(19) United States
(12) Patent Application Publication
(10) Pub. No.: US 2022/0354290 A1
(43) Pub. Date: Nov. 10, 2022

(54) ELASTIC WATER-ABSORBING FLOOR MAT

(71) Applicant: SIMPLE GREEN CO., LTD., Huatan Township, Changhua County (TW)

(72) Inventors: CHEN-I KAO, Huatan Township, Changhua County (TW); SHU-CHEN HUANG, Huatan Township, Changhua County (TW); YA-CHUAN CHOU, Huatan Township, Changhua County (TW); YU-CHUAN WU, Huatan Township, Changhua County (TW); SHANG-CHIEH KAO, Huatan Township, Changhua County (TW); YU-JEN PAN, Huatan Township, Changhua County (TW); HSUEH-FANG KAO, Huatan Township, Changhua County (TW)

(21) Appl. No.: 17/624,314

(22) PCT Filed: Jul. 9, 2019
(86) PCT No.: PCT/CN2019/095171

§ 371 Date: Dec. 31, 2021

(51) Int. Cl. A47G 27/02

(52) U.S. Cl. CPC A47G 27/0281

(57) ABSTRACT

An elastic water-absorbing floor mat, disposed at the bathroom or at the door, comprising an anti-slip layer and an elastic layer, wherein the anti-slip layer is made from a foam material having anti-slip effects and is attached to and disposed on the floor, the elastic layer is made from a foam material having water absorbing effects and is attached to and disposed on the top of the anti-slip layer, and the surface of the elastic layer is provided with a plurality of failure regions that are generally rough and in the form of broken holes. The elastic water-absorbing floor mat can quickly absorb water, and is soft to step on and non-slip.

### FIELD

The present application relates to a water-absorbing floor mat at the doorway of bathroom, and in particular to an elastic water-absorbing floor mat.

### BACKGROUND

In order to prevent the water on soles of feet or shoes from wetting the indoor floor when walking out of the bathroom, most people may place a water-absorbing floor mat at the doorway of bathroom to absorb moisture from the soles of the feet or shoes when stepping on the mat.

In the early days, water-absorbing floor mats at the doorway of bathroom were mostly woven cloth, which mainly used the capillary phenomenon to absorb water, but had no anti-slip effect, and people were prone to slip when stepping on. In order to overcome these disadvantages, some companies have developed water-absorbing floor mats formed by bonding of woven cloth and rubber. This kind of water-absorbing floor mat can absorb water via the woven cloth on the top side, and prevent slipping via the rubber on the bottom layer, which has the effects of proper water absorption and anti-slip.

Although the aforementioned water-absorbing floor mat with a rubber bottom layer has a better use effect than the conventional woven cloth, the time of people stepping on the water-absorbing floor mat is not long. In a short contact time, it is difficult for the woven cloth to quickly absorb the moisture from the soles of feet or shoes by using the capillary phenomenon, and it often occurs that the soles of feet or shoes bring residual moisture onto the indoor floor.

In recent years, the common hard diatomaceous earth (diatomite) water-absorbing floor mat is mainly made by mixing gypsum, diatomaceous earth powder and water, which may quickly absorb water by using its porous material characteristics. The water-absorbing speed thereof is faster than the water-absorbing speed of woven cloth. However, this water-absorbing floor mat has problems such as poor stepping feel, easy-to-break and easy-to-slip (need to be used together with an anti-slip pad), which obviously needs to be improved.

### SUMMARY

An object of the present application is to provide an elastic water-absorbing floor mat that may overcome the above disadvantages, which not only absorbs water fast, but also has a soft stepping feel and does not slip, and is very practical.

In order to achieve the above object, an elastic water-absorbing floor mat disposed at the doorway of bathroom or house is provided according to the present application. The elastic water-absorbing floor mat includes an anti-slip layer and an elastic layer. The anti-slip layer is made of a foam material with anti-slip effect and is attached to the ground. The elastic layer is made of a foam material with water absorbing effect, and is attached to a top side of the anti-slip layer. A plurality of broken zones which are rough and in the form of broken holes is provided on a surface of the elastic layer.

Preferably, the elastic water-absorbing floor mat further includes an intermediate layer attached between the anti-slip layer and the elastic layer, wherein the intermediate layer is made of cloth material.

Preferably, each of the broken zones is formed by breaking the surface of the elastic layer by means of physical techniques or/and chemical techniques.

Preferably, the plurality of broken zones account for 5% to 100% of the total surface area of the elastic layer.

Preferably, the foam material of the elastic layer or/and the foam material of the anti-slip layer is mixed with a water-absorbing material accounting for 5% to 25%.

Preferably, the water-absorbing material refers to mineral powders such as diatomite, pottery clay, clay, and sand, or plant powders such as cotton and agar, or/and chemical powders such as sludge, slag, super absorbent resin, nylon, and polyacrylate.

Preferably, the foam material of the anti-slip layer and the foam material of the elastic layer are mixed with a hydrophobic material.

Preferably, a proportion of the hydrophobic material in the anti-slip layer is higher than a proportion of the water-absorbing material.

Preferably, a proportion of the hydrophobic material in the elastic layer is lower than a proportion of the water-absorbing material.

Preferably, a plurality of uneven portions is provided at a bottom side of the anti-slip layer.

Compared with the existing floor mats, the elastic water-absorbing floor mat of the present application has the beneficial effects of fast water absorption rate, soft stepping feel, and no slippage.

### BRIEF DESCRIPTION OF THE DRAWINGS

FIG. 1 is a perspective view of a preferred embodiment of the present application;

FIG. 2 is a side view of a preferred embodiment of the present application;

FIG. 3 is a perspective view of another preferred embodiment of the present application; and

FIG. 4 is a side view of another preferred embodiment of the present application.

### DETAILED DESCRIPTION OF THE EMBODIMENTS

Hereinafter, several preferred embodiments of the present application will be described in detail below in conjunction with the drawings.

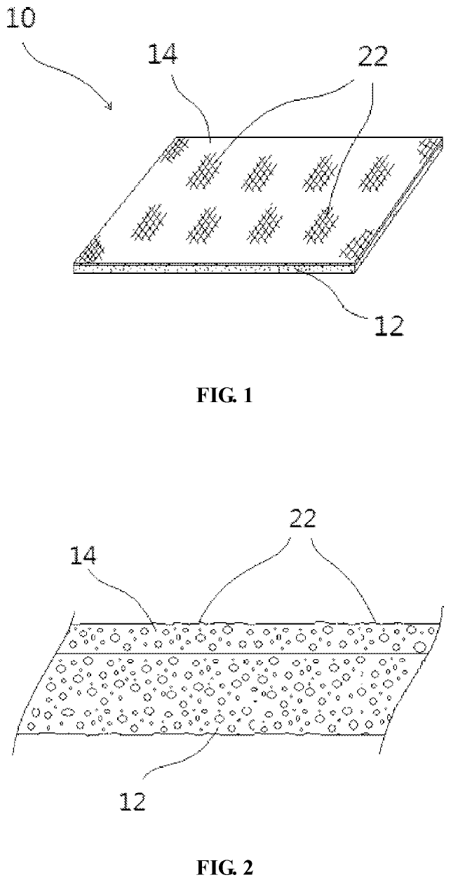

First, referring to FIG. 1 and FIG. 2, an elastic water-absorbing floor mat 10 of a preferred embodiment of the present application, which can be placed at the doorway of a bathroom or a house, includes an anti-slip layer 12 and an elastic layer 14.

The anti-slip layer 12 is a porous foam body made of an elastic foam material with anti-slip effect, such as natural rubber (NR), synthetic rubber (PU), polyvinyl chloride (PVC) or styrene butadiene rubber (SBR) and other foamed materials. In this embodiment, the anti-slip layer 12 adopts natural rubber, which has a plurality of interconnected pores inside.

The elastic layer 14 is a porous foam body made of a foam material with water-absorbing effect, such as natural rubber (NR), synthetic rubber (PU), polyvinyl chloride (PVC) or styrene butadiene rubber (SBR) and other foamed materials. In this embodiment, the elastic layer 14 adopts synthetic rubber, which is attached without glue to the top side of the anti-slip layer 12 by means of the force, generated when foaming raw materials, and the gas pressure, generated when the contained foaming agent takes a chemical change. The thickness of the elastic layer 14 is thinner than the thickness of the anti-slip layer 12, and the top side surface of the elastic layer 14 is further provided with a plurality of broken zones 22 which are generally rough and in the form of broken holes. The plurality of broken zones are formed by breaking the top side surface of the elastic layer 14 by means of physical or/and chemical techniques. The physical technique is the technique of, for example, brushing (by a brush), grinding (by a sandpaper), needle punching (by a needle or sharp tool), laser irradiation or bending (to break the surface of the elastic layer 14), etc. The chemical technique is the technique of corrosion by, for example, a chemical, a solvent or microbe, which is used to communicate internal pores of the elastic layer 14 with the broken zones 22 by means of breaking the original flat surface of the elastic layer 14. The plurality of broken zones 22 may be in the shape of scattered lines, dots, blocks, etc., and account for 5% to 100% of the entire surface area of the elastic layer 14. The higher the ratio, the more parts of the top side of the elastic layer 14 communicating with the internal pores.

Therefore, the elastic water-absorbing floor mat 10 of the present application, on which a bather steps when he walks out of the bathroom, has a soft stepping feel due to the anti-slip layer 12 and the elastic layer 14 both made of porous foam elastic body. In addition, the plurality of rough broken zones 22 provided on the top side of the elastic layer 14 can scrape off and introduce the moisture attached to the soles of the shoes or feet, so that the moisture permeates the elastic layer 14. The elastic layer 14 can quickly absorb the moisture from the soles of the shoes or feet. Further due to the anti-slip property of the anti-slip layer 12 relative to the ground, the elastic water-absorbing floor mat 10 will not slip on the ground when stepped on, avoiding foot sprain or slipping.

Although it is known that porous foam mats (such as yoga mats) made of foam materials have a certain water absorption effect, the water absorption rate is very slow (it takes about 30 seconds to absorb 1 milliliter of water, and if there are words or patterns printed with ink on the surface of the porous foam mat, the time for absorbing 1 milliliter of water at the printing part will be greatly multiplied, which will be about 60 seconds). The water absorption rate of the elastic water-absorbing floor mat 10 of the present application is very fast. According to actual tests, when water drops on the broken zones 22 on the surface of the elastic layer 14, it only takes about 1-2 seconds to absorb 1 milliliter of water. That is, the water absorption rate of the elastic water-absorbing floor mat is about 15-30 times that of the known porous foam mats. Therefore, the broken zones 22 indeed improve the water absorbing effect of the elastic layer 14.

The higher the proportion of the broken zones 22 to the total surface area of the elastic layer 14, the higher the probability of contacting the broken zones 22 when the shoes or feet step on the elastic water-absorbing floor mat 10, which can ensure that the water on the soles of the shoes or feet is completely and quickly absorbed. If the proportion of the broken zones 22 to the total surface area of the elastic layer 14 is low, the broken zones can be scattered in the middle of the top side of the elastic layer 14, which are easy to be stepped on by shoes or feet.

Moreover, the elastic layer 14 can also prevent the shoes or feet from slipping on its surface, and after it absorbs the moisture on the bottom side of the shoes, the excess moisture that cannot be absorbed may flow downward and be absorbed by the anti-slip layer 12 of the porous continuous structure. That is, the anti-slip layer 12 can not only prevent slippage, but also absorb the water flowing out of the elastic layer 14, so that the water absorbing effect of the elastic water-absorbing floor mat 10 is better.

The elastic water-absorbing floor mat 10 of the present application may further improve the water absorbing effect in addition to the above-mentioned structures of the broken zones 22, and the method is to add a water-absorbing material accounting for 5%-25% to the foam material of the elastic layer 14 (a ratio higher than 25% may reduce the flexibility of the elastic layer 14). The water-absorbing material refers to mineral powders such as diatomaceous earth (or diatomite), pottery clay, clay, and sand, or plant powders such as cotton and agar, or/and chemical powders such as sludge, slag, super absorbent resin, nylon, and polyacrylate. The anti-slip layer 12 may also be added with an appropriate amount of the water-absorbing material.

According to actual tests, when the proportion of water-absorbing material added to the elastic layer 14 (the surface of which has the broken zones 22) is 5%, the water-absorbing time can be further shortened by about 15% to 20% compared with the water-absorbing time of the elastic layer 14 without the water-absorbing material. For example, if it takes 2 seconds for the broken zones 22 on the surface of the elastic layer 14 to absorb 1 milliliter of water, the water-absorbing time can be shortened by 0.3-0.4 seconds after the elastic layer 14 is added with the water-absorbing material accounting for 5%, that is, the water-absorbing time is shortened to 1.6-1.7 seconds. If it takes 1 second for the broken zones 22 on the surface of the elastic layer 14 to absorb 1 milliliter of water, the water-absorbing time can be shortened by 0.15-0.2 seconds after the elastic layer 14 is added with the water-absorbing material accounting for 5%, that is, the water-absorbing time is shortened to 0.8-0.85 seconds.

When the proportion of water-absorbing material added to the elastic layer 14 is 10%, the water-absorbing time can be further shortened by about 20% to 25% compared with the water-absorbing time of the elastic layer 14 without the water-absorbing material. For example, if it takes 2 seconds for the broken zones 22 on the surface of the elastic layer 14 to absorb 1 milliliter of water, the water-absorbing time can be shortened by 0.4-0.5 seconds after the elastic layer 14 is added with the water-absorbing material accounting for 10%, that is, the water-absorbing time is shortened to 1.5-1.6 seconds. If it takes 1 second for the broken zones 22 on the surface of the elastic layer 14 to absorb 1 milliliter of water, the water-absorbing time can be shortened by 0.2-0.25 seconds after the elastic layer 14 is added with the water-absorbing material accounting for 10%, that is, the water-absorbing time is shortened to 0.75-0.8 seconds.

When the proportion of water-absorbing material added to the elastic layer 14 is 15%, the water-absorbing time can be further shortened by about 25% to 30% compared with the water-absorbing time of the elastic layer 14 without the water-absorbing material. For example, if it takes 2 seconds for the broken zones 22 on the surface of the elastic layer 14 to absorb 1 milliliter of water, the water-absorbing time can be shortened by 0.5-0.6 seconds after the elastic layer 14 is added with the water-absorbing material accounting for 15%, that is, the water-absorbing time is shortened to 1.4-1.5 seconds. If it takes 1 second for the broken zones 22 on the surface of the elastic layer 14 to absorb 1 milliliter of water, the water-absorbing time can be shortened by 0.25-0.3 seconds after the elastic layer 14 is added with the water-absorbing material accounting for 15%, that is, the water-absorbing time is shortened to 0.7-0.75 seconds.

When the proportion of water-absorbing material added to the elastic layer 14 is 25%, the water-absorbing time can be further shortened by about 35% to 40% compared with the water-absorbing time of the elastic layer 14 without the water-absorbing material. For example, if it takes 2 seconds for the broken zones 22 on the surface of the elastic layer 14 to absorb 1 milliliter of water, the water-absorbing time can be shortened by 0.7-0.8 seconds after the elastic layer 14 is added with the water-absorbing material accounting for 25%, that is, the water-absorbing time is shortened to 1.2-1.3 seconds. If it takes 1 second for the broken zones 22 on the surface of the elastic layer 14 to absorb 1 milliliter of water, the water-absorbing time can be shortened by 0.35-0.4 seconds after the elastic layer 14 is added with the water-absorbing material accounting for 25%, that is, the water-absorbing time is shortened to 0.6-0.65 seconds.

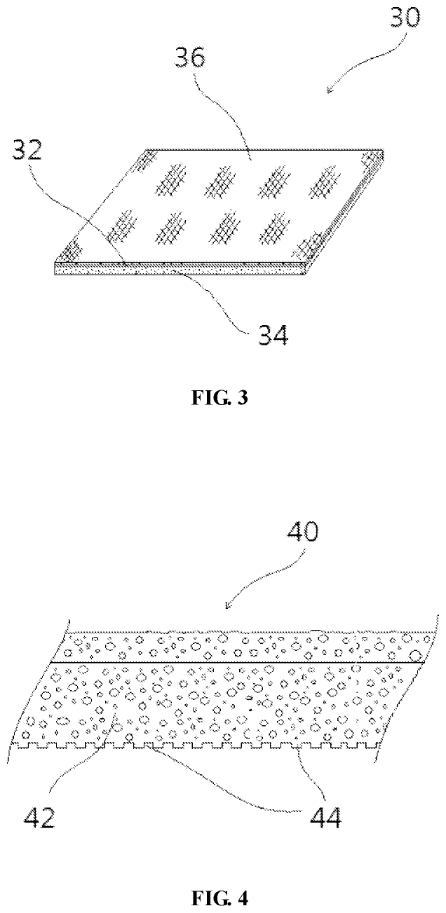

FIG. 3 shows another preferred embodiment of the elastic water-absorbing floor mat 30 of the present application, which has a structure similar to the elastic water-absorbing floor mat 10 of the previous embodiment. The difference is as follows. The elastic water-absorbing floor mat 30 further includes an intermediate layer 32, which is placed between the anti-slip layer 34 and the elastic layer 36, and is composed of a porous cloth such as a non-woven fabric or a sandwich mesh. In this way, after the elastic layer 36 absorbs water, the excess water can be absorbed by the intermediate layer 32, and the three-dimensional and loose fabric structure of the intermediate layer 32 is more helpful for air-drying the absorbed water.

Secondly, the anti-slip layer 34 may be a water-absorbing foam material, such as the aforementioned foam material of natural rubber (NR), synthetic rubber (PU), polyvinyl chloride (PVC) or styrene butadiene rubber (SBR) etc., which can store the excess water after absorption of the intermediate layer 32 and drain (the water is discharged to the bottom side of the anti-slip layer 34), or a non-absorbent foam material, such as plastic, which can prevent water from being discharged to the bottom side of the anti-slip layer 34.

In fact, when the bather walks out of the bathroom, the water on the soles of shoes is not too much, mostly only about a few milliliters. Therefore, when stepping on the elastic water-absorbing floor mat of the present application, most of the water is absorbed by the elastic layer (or by the elastic layer and the intermediate layer), and the amount of water flowing to the anti-slip layer is not much. Even if there is water discharged to the bottom side of the anti-slip layer, the anti-slip effect of the anti-slip layer will not be affected.

FIG. 4 shows another preferred embodiment of the elastic water-absorbing floor mat 40 of the present application, which has a structure similar to the elastic water-absorbing floor mat 10 of the previous embodiment. The difference is as follows. A plurality of uneven portions 44 are provided at a bottom side of the anti-slip layer 42. In this way, the uneven portions 44 can generate several gaps on the bottom side of the anti-slip layer 42 for air circulation, thereby improving the air-drying effect of the bottom side of the elastic water-absorbing floor mat 40.

In addition, the foam material of the anti-slip layer and the elastic layer of the present application may be mixed with hydrophobic materials, such as glass particles or/and metal particles and other non-hydrophilic materials. When the anti-slip layer and the elastic layer are added with hydrophobic materials, the anti-slip layer and the elastic layer are prompted to discharge water after absorbing the water, by virtue of the water repellent property of hydrophobic materials. Since the elastic layer is mainly used to absorb water, a proportion of the hydrophobic material in the elastic layer is lower than a proportion of the water-absorbing material. If the water-absorbing material is added in the anti-slip layer, a proportion of the hydrophobic material in the anti-slip layer may be higher than a proportion of the water-absorbing material. It is also applicable that no water-absorbing material is added in the anti-slip layer and only the hydrophobic material is added therein.

It can be seen from the above that, the elastic water-absorbing floor mat provided by the present application is formed by bonding the anti-slip layer and the elastic layer, the surface of the elastic layer is further provided with a plurality of broken zones, and the water-absorbing material or the hydrophobic material may be added to the elastic layer. The elastic water-absorbing floor mat absorbs water quickly, has a soft stepping feel and does not slip, which can solve the common problems of the hard diatomite water-absorbing floor mat in recent years, such as easy-to-break, easy-to-slip and poor sense of touch. It can also overcome the disadvantages of conventional woven cloth floor mat such as poor water absorbing effect and easy-to-slip, and is very practical. Therefore, it has industrial practicability.

Although the present application has been disclosed as above via the preferred embodiments, it is not intended to limit the present application. Any one of ordinary skill in the art can make modifications and improvements without departing from the spirit and scope of the present application. Therefore, the scope of protection of the present application should be defined by the appended claims.

1. An elastic water-absorbing floor mat, disposed at a doorway of a bathroom or a house, comprising an anti-slip layer and an elastic layer, wherein:
the anti-slip layer is made of a foam material with anti-slip effect and is attached to the ground; and
the elastic layer is made of a foam material with water absorbing effect, and is attached to a top side of the anti-slip layer, a plurality of broken zones which are rough and in a form of broken holes are provided on a surface of the elastic layer.

2. The elastic water-absorbing floor mat according to claim 1, further comprising an intermediate layer attached between the anti-slip layer and the elastic layer, wherein the intermediate layer is made of cloth material.

3. The elastic water-absorbing floor mat according to claim 1, wherein each of the broken zones is formed by breaking the surface of the elastic layer by means of physical or/and chemical techniques.

4. The elastic water-absorbing floor mat according to claim 3, wherein the plurality of broken zones account for 5% to 100% of a total surface area of the elastic layer.

5. The elastic water-absorbing floor mat according to claim 1, wherein the foam material of the elastic layer or/and the foam material of the anti-slip layer is mixed with a water-absorbing material accounting for 5% to 25%.

6. The elastic water-absorbing floor mat according to claim 5, wherein the water-absorbing material is mineral powders such as diatomite, pottery clay, and clay, or plant powders such as cotton and agar, or/and chemical powders such as sludge, slag, super absorbent resin, and nylon.

7. The elastic water-absorbing floor mat according to claim 1, wherein the foam material of the anti-slip layer and the foam material of the elastic layer are mixed with a hydrophobic material.

8. The elastic water-absorbing floor mat according to claim 7, wherein a proportion of the hydrophobic material in the anti-slip layer is higher than a proportion of the water-absorbing material.

9. The elastic water-absorbing floor mat according to claim 7, wherein a proportion of the hydrophobic material in the elastic layer is lower than a proportion of the water-absorbing material.

10. The elastic water-absorbing floor mat according to claim 1, wherein a plurality of uneven portions is provided at a bottom side of the anti-slip layer.

11. The elastic water-absorbing floor mat according to claim 2, wherein a plurality of uneven portions is provided at a bottom side of the anti-slip layer.

12. The elastic water-absorbing floor mat according to claim 2, wherein each of the broken zones is formed by breaking the surface of the elastic layer by means of physical or/and chemical techniques.

13. The elastic water-absorbing floor mat according to claim 12, wherein the plurality of broken zones account for 5% to 100% of a total surface area of the elastic layer.

14. The elastic water-absorbing floor mat according to claim 2, wherein the foam material of the elastic layer or/and the foam material of the anti-slip layer is mixed with a water-absorbing material accounting for 5% to 25%.

15. The elastic water-absorbing floor mat according to claim 14, wherein the water-absorbing material is mineral powders such as diatomite, pottery clay, and clay, or plant powders such as cotton and agar, or/and chemical powders such as sludge, slag, super absorbent resin, and nylon.
